(19) United States
(12) Patent Application Publication
(10) Pub. No.: US 2002/0050719 A1
(43) Pub. Date: May 2, 2002

(54) Co-probe power generation system

(76) Inventors: Robert I. Caddell, Aurora, CO (US); Paul L. Prosser, Aurora, CO (US)

Correspondence Address: Ramon L. Pizarro, 3515 South Tamarac Drive, Suite 200, Denver, CO, 80237, US

(21) Appl. No.: 09/878,654

(22) Filed: Jun. 11, 2001

Related U.S. Application Data
(60) Provisional application No. 60/211,102, filed on Jun. 12, 2000.

(51) Int. Cl. H02P 9/04

(52) U.S. Cl. 290/54

(57) ABSTRACT

A fluid moving system that includes a multiplicity of electrode elements mounted in spaced relationships to one another adjacent along a surface. The electrode elements produce charged particles by a corona-type discharge. The electrode elements are also used for delivering progressively changing electric potentials along the smooth surface in order to create an electric potential field for propelling charged particles from one electrode element toward the next and thereby inducing a surface layer fluid flow over the surface. A switching mechanism for reversing the direction of the corona discharge and the direction of the moving charged particles is also incorporated into the system in order to reinforce and accelerate the flow.

### REFERENCE TO RELATED APPLICATIONS

This application claims the benefit of my provisional application having Ser. No. 60/211,102, filed Jun. 12, 2000, now abandoned.

### BACKGROUND OF THE INVENTION

(a) Field of the Invention

This invention generally relates to a system and method for accelerating fluids. More particularly, but not by way of limitation, to a system for generating power from fluids accelerated by way of an electrical potential difference.

(b) Discussion of Known Art

In a letter to the editor of the publication The Review of Scientific Instruments April, 1954, “Ionic Pump” by A. M. Gurewitsch and W. F. Westendorf of the General Electric Research Laboratory, an ionic pump that depends upon the production of ions by electrons oscillating in a combined electric and magnetic field is discussed. According to this article in an ionic pump ions are accelerated by an electric field and are driven into absorbing surfaces represented by carbon disc or other absorbing materials. In U.S. Pat. No. 1,980,521 Hahn, titled Method for Supplying and Cleaning Gas by Electrical Charge, Hahn mentions the use of electrodes to create and accelerate electric wind; the sole purpose of his patent is to clean the air in a room.

U.S. Pat. No. 2,925,214 to Gurewitsch, et. al. Ionic Vacuum Pump, as discussed above.

U.S. Pat. No. 3,080,515 to Kehoe, Methods and Apparatus for Generating Electricity. Kehoe uses a moving high-temperature-electric arc to heat a pressurized ionized gas in a small chamber and extracts electrical energy from the moving arc.

U.S. Pat. No. 3,120,736 to Gignoux Method and Apparatus for Colloidal Propulsion. Gignoux's invention involves the electric propulsion of space vehicles by extracting colloidal particles from electrodes, accelerating the particles at a specific rate controlled by a pre-calculated voltage, and forcing the spacecraft through space at a high velocity.

U.S. Pat. No. 3,122,882 Schultz, et. al., Propulsion Means. Schultz's invention is similar to that of Gignioux, above, in that he wants to use colloidal propulsion to provide acceleration to spacecraft; instead of taking particles from electrodes as Gignioux suggests, Schultz uses a stored propellant (water droplets of micron size stored in a vacuum) as his propulsion means. No electrodes or charged particles are involved with Schultz's invention. U.S. Pat. No. 3,129,376 McCarthy, Electric Generator. McCarthy's technology uses a Van De Graff static electricity generator to provide static electricity to an egg-shaped conductor and extract usable electrical current from the static electricity.

U.S. Pat. No. 3,224,497 Blomgren Method and Apparatus for Lowering the Temperature of a Heated Body. Blomgren utilizes electrodes excited by a high voltage to create a corona discharge and he uses the ions generated by the system to control the energy level of flames, and flames within a tube, and also the energy level of heated metal sheets.

U.S. Pat. No. 3,224,485 Blomgren, Heat Control Device and Method.

U.S. Pat. No. 3,526,268 Robinson Corona Discharge Heat Transfer. Robinson uses a corona discharge established on a heated wire to provide a heat transfer method for heated surfaces and appliances. U.S. Pat. No. 4,114,046 to Yousef, Electrical Generator Employing Natural Energy to Power Same. Yousef's patent provides for an irregularly-shaped-closed-loop track with electromagnets attached at intervals along the track. A vehicle Yousef calls “blocks” are also equipped with electromagnets. The blocks are powered around the track by some natural resource such as wind energy, solar energy and/or wave energy. As the electromagnets of the blocks pass the electromagnets of the track an alternating current is generated which is either used or put on a utility grid. U.S. Pat. No. 4,408,127 to Santos teaches a closed-loop system that uses a battery operated pump to move fluid from a reservoir through a conduit to power a primary turbine that produces electricity. The moving fluid is then used to power a secondary turbine that also produces electricity; this second supply of electricity is used to charge the battery that drives the pump. The electricity made through the primary turbine is used to perform work. U.S. Pat. No. 4,511,806 to May, titled Pressure Drop Power Generation teaches a device used in emergency situations such as where lighting is needed in a smoke-filled room. A source of highly compressed air is used to operate a small portable turbine generator that provides short-term power to those in need.

U.S. Pat. No. 5,813,217 to Beall, teaches a method to propel space vehicles at high velocities through the use of the spacecrafts own momentum. An ion beam current of an unknown source delivers a continuous stream of mass to the vehicle. The mass stream is decelerated and transfers its momentum to the vehicle as thrust. The vehicle reaccelerates the mass stream back to its origin, and the vehicle goes faster and faster.

U.S. Pat. No. 5,734,202 to Shuler titled Method and Apparatus for Generating Electricity Utilizing a Forced Recirculating Air Tunnel describes a continuous closed-loop airflow pathway. A power-consuming propeller is used to circulate the air through the closed loop. The propeller preferably receives its power from a solar panel, but could be powered by an internal combustion engine, or the like. As the wind circulates through the closed loop, it is directed through a plurality of wind turbines which create electrical power that is then fed into the grid of a utility.

U.S. Pat. No. 4,731,545 to Lerner, et. al. titled Portable self-Contained Power Conversion Unit converts the energy from a source such as a garden hose to drive a small turbine that in turn produces enough electrical power to operate portable tools like drills, grinding wheels, power saws, and so on.

U.S. Pat. No. 5,005,361 to Phillips, et. Al., titled Ion Repulsion Turbine uses a high temperature plasma and a source of high voltage electricity to produce power through a turbine. A plurality of ion repulsion discharge chambers is located along the perimeter of the power-production turbine. These discharge chambers are used to accelerate the ions and a condenser and a pump are then used to return condensed gases back to the plasma generator, where the overall process then repeats itself over and over.

### SUMMARY

It has been discovered that the problems left unanswered by known art can be solved by providing an open or closed-loop system of methods and mechanisms, having no moving parts, which are used for moving any and all fluids at controlled velocities ranging in speed from less than one mile per hour to speeds exceeding one Mach, and it also relates to systems and methods for attracting and capturing ambient fluids for increasing the mass and weight of the fluids being moved by the said methods and mechanisms to perform work, and it relates further to the propulsion of devices such as a turbine or paddlewheel which in turn creates a substantial amount of shaft horsepower that can be utilized, for example, for the production of electrical power. The method of producing fluid flow that is used to carry out the objects of this invention and the various illustrated embodiments thereof comprises the creation and utilization of electric fields so that progressively changing, or different, potentials are produced, and so that charged ionic particles existing, or provided by induced corona, near the electric field are propelled along the field and influence a corresponding flow of fluid medium, like air, in which the electric field is produced. The fluid medium may be made to move in a laminar or surface fluid flow so that it may be utilized to produce a force that can in turn be utilized to drive turbine blades and paddle wheels, or the like, used in the production of shaft horsepower which in turn can be used to create electrical power, or to produce pressure differentials sufficient to facilitate the flow of the ambient medium, or other fluid through pipes, ducts, or the like in which the electric fields are produced.

In one embodiment of the invention in the power production field, fluid-force tunnels of conventional wind-tunnel-reduced-throat design are provided with an ionic-fluid-force propulsion system that employs charged electrodes, with constantly changing polarities, to accelerate and drive ions or other charged particles in a unified direction. The charged particles produce a reactive thrust on the electrodes and also create high velocity streams of fluids that are forced toward the throat and thereby create an area of compression. This area of compression creates a high-pressure zone that is utilized to drive the blades of any conventional turbine, for example a Tesla Turbine and/or the impellers of a paddle-wheel-like turbine, and the like. The fluid-force generator's interior surface is concavely curved to accommodate the narrow throat area, and the electrode elements are arranged in a plurality of parallel rows that are approximately perpendicular to the longitudinal axis of the tunnel. The rows of electrode elements are spaced from one another at predetermined intervals along a line or zone extending back from the fluid-force generator tunnel's larger end along the curve of the surface and toward the throat area. Each electrode element is comprised of a rod or bar having a multiplicity of individual electrode points directed along the curve toward the adjacent row of electrodes in the direction of the fluid flow. All of the points are positioned to lie in substantially the same plane, generally parallel to the fluid-force generator tunnel's surface. The electrode points may be spaced somewhat from the tunnel surface or mounted flush with the surface. Although the fluid-force generation system can work with a number of standard power supplies, this system operates with the greatest efficiency when the electrodes are charged by the power supply outlined in conjunction with the present invention, and in resonance. Alternating current excitation of the electrodes is presently preferred although for some applications a direct current may be used; in either case, the electrodes in successive rows are charged in such a manner as to create an electric potential gradient or electric field through which ions or other charged particles are accelerated to attain high velocities in moving over the rows of electrodes. When alternating current excitation is employed the operation of the system is analogous to that of a squirrel cage induction motor, a predetermined phase difference being maintained between the rows of electrodes, and the system being operated to propel the masses of charged particles at a resonant velocity sufficient to maintain the desired fluid-flow velocity. When direct current is used, each row of electrodes is at a higher potential than the preceding row in the direction of the fluid movement. Consequently, between the first and last rows a very high potential, equal to the sum of voltages between each row must be employed. The ions or charged particles move successively from one row to the next and create an aura or “electric wind” by dragging fluids, such as air, along the fluid-force generator tunnel's internal surface. By providing a sufficiently high potential gradient, within a good electrical conductor, positioned in or around the pointed electrodes, corona discharge is established thereby creating an abundance of ions and greatly facilitating the moving of fluids along the fluid-force generator tunnel's surface. A substantial streamlined laminar or surface layer flow of fluids, such as air, is obtained by the system of the present invention, which thus avoids a lot of turbulence and increases the overall efficiency of the system.

The concavely curved surface of the wind generator's inner walls may be employed to minimize the capture and loss of charged particles by the electrodes; this is accomplished by orienting the electrodes to drive the ions or charged particles around the curved walls thereby producing centrifugal forces which motivate the ions or particles away from the curved surface. These centrifugal forces are generally in the same direction as, and supplement, the working pressure produced in the throat of the fluid-force generator tunnel.

As previously stated, the preferred excitation systems employ periodically changing potentials, and these systems are designated herein as alternating potential systems. At resonance each pulse of ions will flow across or pass the electrode attracting them when that electrode changes polarity, and the charged particles are further accelerated in the same flow direction by repulsion from this electrode and attraction toward the next electrode which is now of opposite polarity. If the accelerating voltage gradient between the electrodes and the frequency are properly adjusted, these pulses of ions will flow from one electrode to the next in synchronism or resonance with respect to the changing electrode potentials. This resonance may be obtained by adjusting either the accelerating voltage gradient or the frequency. When resonance is achieved, a minimum number of ions or charged particles will be captured by the electrodes thereby minimizing the current loss and increasing the efficiency of operation. This current loss may be further decreased by decreasing the width of the ion pulse so that more of the ions can cross the electrode while there is essentially no electric field between electrodes. The effectiveness of the alternating potential excitation including the minimizing of current losses may be controlled by the selection of the wave form of the alternating potential and also by various designs of the configuration and dimensions of the electrodes.

This invention exhibits utility in a wide variety of applications such as improving the efficiency of wind farms, power generators and anywhere else where systems need to rely upon prime movers such as naturally produced winds or engines and their power source or fuel supply. One of the most pressing needs facing the world today is the plentiful-nonpolluting production of affordable-clean electrical power. Carbon-fuel-burning utilities are polluting the earth's atmosphere and causing damage to the planet's high-altitude protective ozone layer. Utilization of the power generating invention described herein can ameliorate the environmental problems caused by the burning of these fossil fuels. Many of the negative aspects associated with today's state-of-the-art electrical power generation and transmission are utilized in this invention as positive features.

All conventional fossil-burning utilities have the common-costly problems associated with long-distance-alternating-current (AC) power transmission. These problems include: corona discharge which, unless the transmission line has an expensive large diameter conductor can leak up to forty percent of the transmitted energy; storm induced transmission line downtime; lightning strikes; and losses that are attributed to power-line resistance and inductance. Whereas High-Voltage-Direct-Current (HVDC) transmission lines have less line losses than HVAC, they have many undesirable and limiting features. New power generation stations must continue to be built to satisfy the growing demand for electrical energy and to somewhat reduce the need for long-distance power transmission lines, which are no substitute new generation.

It is an object of the present invention to provide a new system for generating winds at variable and controllable velocities.

It is another object of this invention to provide a new power supply system that when utilized in conjunction with certain electrode spacing, wave forms, voltages and frequencies, operating preferably at resonance, create a desired wind velocity capable of performing work.

It is another object of this invention to provide an improved system and method employing electric fields to produce a flow of fluid media.

It is another object of this invention to provide an improved and reliable method to generate electricity without the burning of fossil fuels or any other type of fuel.

It is another object of this invention to provide an improved system for producing a high velocity movement of fluid and non-fluid matter to produce reactive thrust that may be used to turn turbine blades, or the like, such as used in the production of electricity.

It is another object of this invention to provide an improved method of creating fluid forces capable of efficiently turning turbine blades at their maximum rated speeds.

It is another object of this invention to provide an improved system for maintaining a flow of fluids through wind tunnels, ducts and the like with a minimum of turbulence.

It is a further object of this invention to provide an improved fluid-force system for providing controlled forces in any desired direction as any application might call for.

It should also be understood that while the above and other advantages and results of the present invention will become apparent to those skilled in the art from the following detailed description and accompanying drawings, showing the contemplated novel construction, combinations and elements as herein described, and more particularly defined by the appended claims, it should be clearly understood that changes in the precise embodiments of the herein disclosed invention are meant to be included within the scope of the claims, except insofar as they may be precluded by the prior art.

### DRAWINGS

The accompanying drawings illustrate preferred embodiments of the present invention according to the best mode presently devised for making and using the instant invention, and in which:

FIG. 1 is a block diagram of a new and unique power supply system for use with the invention;

FIG. 2 is a perspective view of the fluid-force generator and the rows of conducting electrodes secured in an insulated tubular housing of plastic, fiberglass, composites or the like;

FIG. 3 is an enlarged sectional view of the throat area along the line A-A showing the electrodes of FIG. 2;

FIG. 4 is a side view of the fluid-force generator as indicated in FIG. 2;

FIG. 5 illustrates the paddle-wheel-turbine blades and its side support panels, bearing caps and shaft;

FIGS. 6, 7 and 8 are graphs of three different forms of alternating potential waves suitable for use in the systems of the invention;

FIG. 9 is a schematic diagram of an alternating current excitation system suitable for use in the systems of the invention;

FIGS. 10, 11 and 12 are graphs illustrating wave forms similar to those of FIGS. 6, 7 and 8 respectively and resulting from the operation of the system of FIG. 9;

FIG. 13 is a schematic diagram if a direct current excitation system;

FIGS. 14, 14A and 14B illustrate another embodiment of the invention designed for use with the power-supply of FIG. 1;

FIGS. 15, 16 and 17 are diagrams illustrating the characteristics of operation of the system when applying alternating wave forms as shown in FIGS. 6, 7 and 8 respectively;

FIG. 18 is a schematic diagram illustrating another embodiment of an excitation system of the invention;

FIG. 19 is a graph illustrating the characteristics of operation of the system of FIG. 18;

FIG. 20 is a voltage curve applicable to a portion of the system of FIG. 18;

FIG. 21 is a sectional view of another electrode arrangement suitable for operation with the system illustrated in FIG.18;

FIG. 22 is a sectional view through a line of electrodes for illustration of another embodiment of the invention;

FIG. 23 is a diagrammatic view of the transformer connection for the electrodes of FIG. 22;

FIG. 24 is a graph illustrating the vector relationship of the potentials produced by the transformer of FIG. 23;

FIG. 25 is a schematic diagram of an electromechanical system providing speed control;

FIG. 26 is a graph showing a potential wave form of the excitation system for the system of FIG. 25;

FIG. 27 and 28 are graphs illustrating high and low speed characteristics of the control system of FIG. 25.

### DETAILED DESCRIPTION OF PREFERRED EXEMPLAR EMBODIMENTS

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

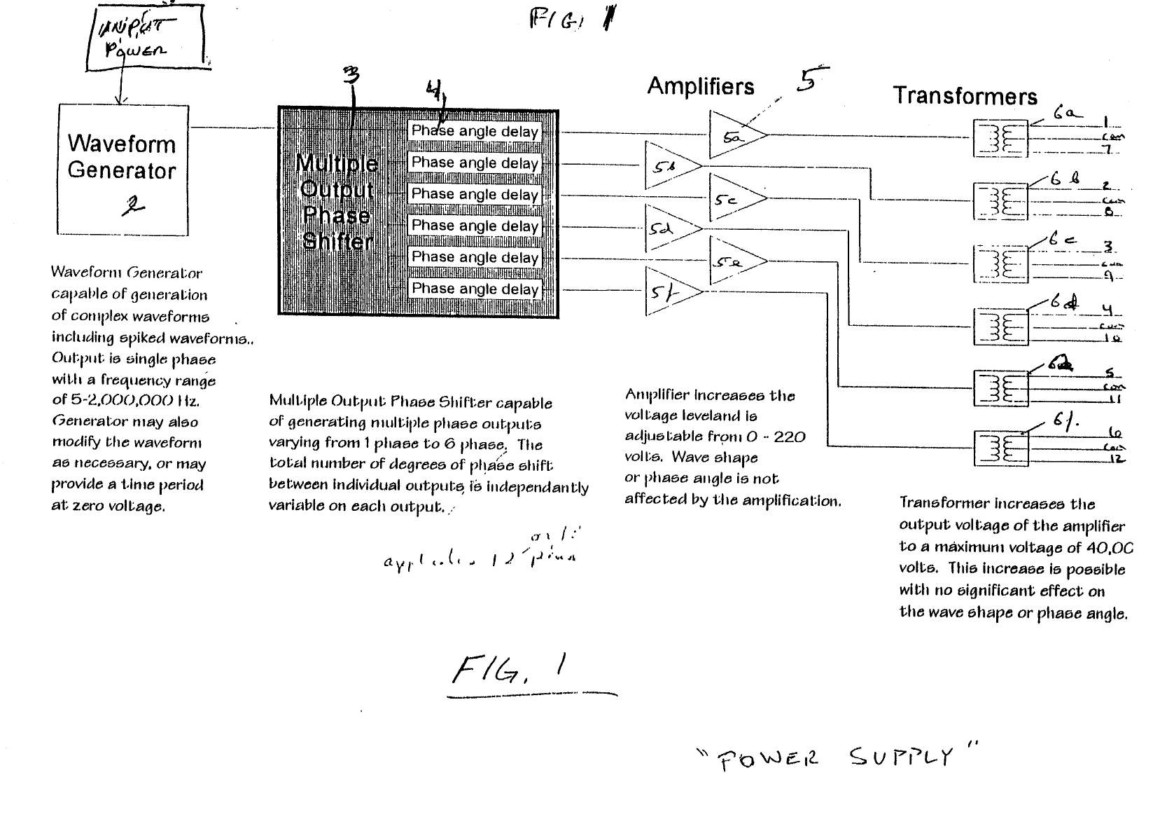

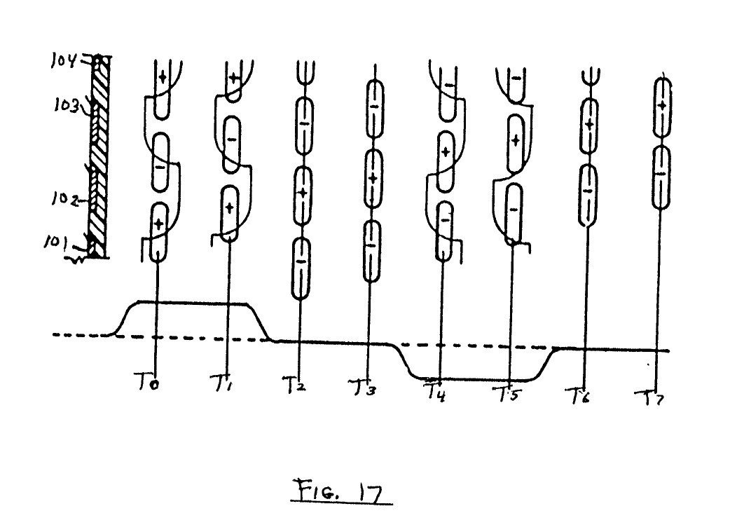

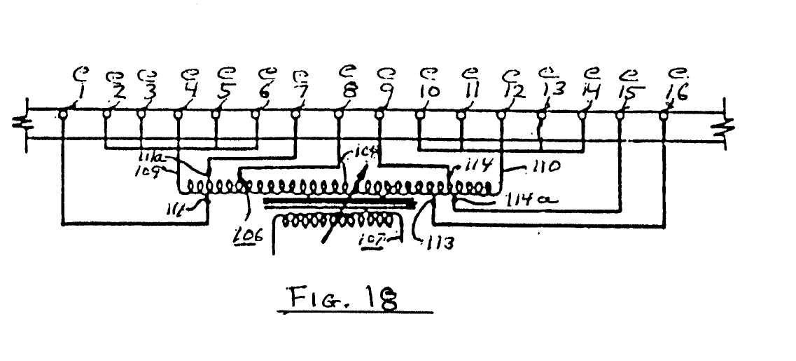

Turning now to FIG. 1 where a block diagram of a new and unique power supply system for use with this invention has been shown. The invention described herein employs a power supply having an alternating potential with periodically changing and timed electric potentials having specified waveforms, a multiple output phase shifter, voltage amplifiers and transformers to further increase the power supply's output voltage. The block diagram illustrated in FIG. 1 is an example of this invention's power supply system. FIG. 1 comprises a source of input power such as that provided by standard solar panels (not shown), a fluid-force-driven turbine (not shown), or any prime mover such as a conventional internal combustion power generator, or the like, as indicated at 1. A waveform/frequency generator 2 capable of generating a wide range of complex waveforms, including spiked waveforms, a single-phase voltage with a frequency range of five (5) to two million (2,000,000) Hz. Generator 2 may also be used to modify the waveforms as necessary to achieve resonance in the system, and provide an intermittent/scheduled time-delay period at zero (0) voltage. The multiple-output-phase shifter 3 receives its input from waveform generator 2 and is capable of generating multiple-phase outputs varying from one (1) phase to twelve (12) or more phases. The phase shifter illustrated at 3 shows a six (6) output phase-shifter. The total number of degrees of phase shift between individual outputs is independently variable on each output shown at 4a, 4b, 4c, 4d, 4e and 4f and having nomenclature of “Phase angle delay.” Amplifiers 5a, 5b, 5c, 5d, 5e and 5f are employed to increase the voltage and power levels, and are designed to be adjustable from zero (0) volts to two-hundred and twenty (220) volts respectively. The waveforms, phase angles and frequencies are not affected by the operation of the amplifiers. The amplified voltage of 5a through 5f is fed into transformers 6a, 6b, 6c, 6d, 6e and 6f respectively, and they are employed to further increase the output voltage of amplifiers to a maximum voltage of forty-thousand (40,000) volts. This voltage increase has no significant effect on the chosen waveform or phase angle. The output leads of transformers 6a through 6f are paired to work in conjunction with other schematics illustrated, for example, FIGS. 14 and 25 of this invention that is a schematic diagram of a system providing speed-changing control. It will be noted on FIG. 1 that transformer 6a has leads that are connected to electrodes e1 and e7; transformer 6b leads go to electrodes e2 and e8; transformer 6c leads go to electrodes e3 and e9; transformer 6d leads go to electrodes e4 and e10; transformer 6e leads go to electrodes e5 and e11; and transformer 6f leads go to electrodes e6 and e12. The center tap on transformers 6a through 6f are common lines for grounding. This arrangement of leads from the transformers to the electrodes produce alternating current potentials which are 30 degrees out of phase; for example, the voltage on e2 lags 30 degrees behind the voltage on e1, e3 lags 30 degrees behind e2 and so on through the series of electrodes. The voltage wave on the lower terminal of the transformer is 180 degrees out of phase with the voltage on the upper terminal.

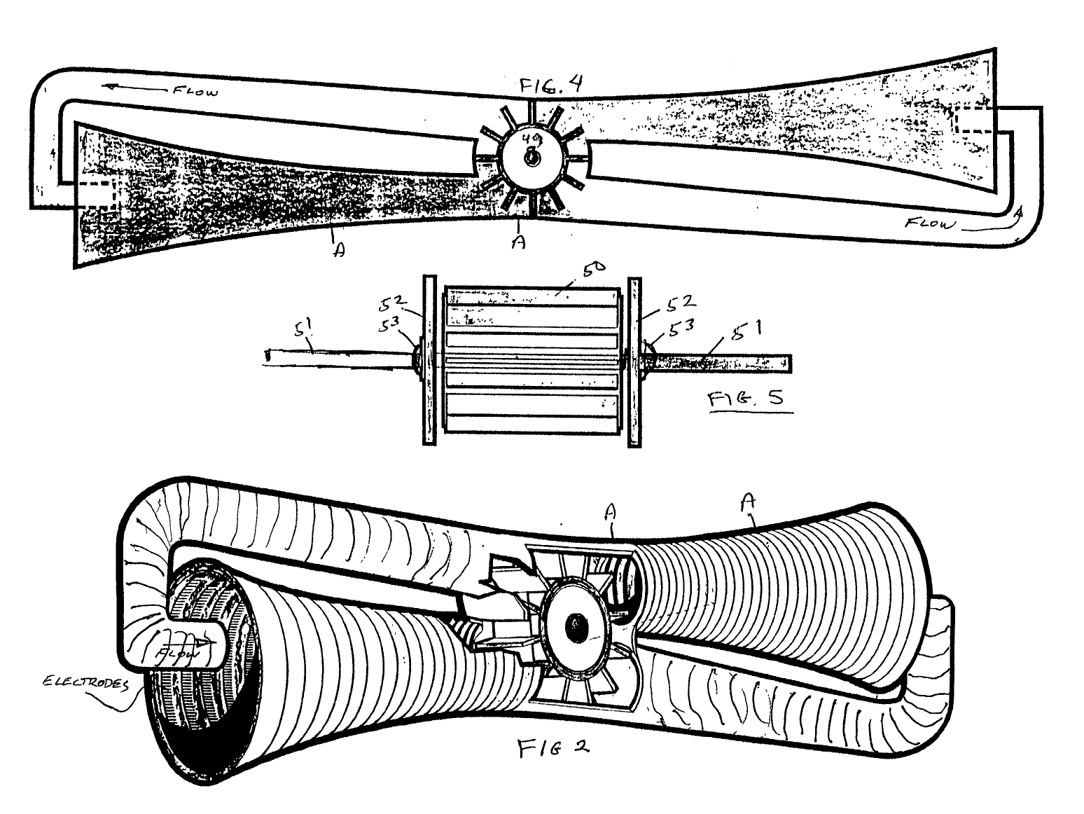

In one embodiment of the invention in the field of fluid-force generation, which employs rows of intermittently positive and negative charged electrodes to push and pull (pump) accelerating ionic winds to and from the electrode rows, thus producing a reactive thrust on the electrodes, thereby creating high velocity streams of fluids, such as air, and a resulting boundary layer of low pressure along the profile of the invention's employed application embodiments. The fluid flow systems of this invention may be used for a wide range of applications wherein it is desirable to provide a laminar flow of fluid near the surface, and an example of this is shown in FIG. 2 where the application is to generate fluid-forces in two identical wind generators, operating simultaneously from the same power supply as described in FIG. 1, to drive a paddle-wheel-like turbine from both the top and bottom.

In FIG. 2 rows of charged electrodes receive electrical charges from the power supply indicated in FIG. 1. The application illustrated in FIG. 2 is that of a fluid to energy system comprising two identical fluid-force generators 2a and 2b, operating from a common power supply FIG. 1 with fluid-force generator 2a providing fluid energy to the top section of a paddle-wheel-type turbine 13, and fluid-force generator 2b providing fluid-force energy in the opposite direction of that of fluid-force generator 2a, to the bottom section of turbine 13. Turbine 2a has inlet portion 7 and turbine 2b has inlet portion 8, and turbine 2a has an outlet portion 9, while turbine 2b has an outlet portion 10. Both turbine 2a and 2b have identical constricted portions numbered 11 and 12 respectfully. The gradually reducing cross section area of each inlet portion is provided to create an increase in velocity of flow as the fluid reaches the narrowed throat portions 11 and 12 where the fluid-force is employed to drive turbine 13. The discharge portion 9, which, after helping to turn the uppermost section of the turbine blades 13 retains some of the fluid's velocity, which is then significantly increased by the actions and reactions of electrodes located in the discharge portion 9. This increase in velocity in 9 also helps in the driving of the turbine blades 13 because the reaction on the turbine blades is one of a strong suction force. The fluid force thus generated in discharge portion 9 is then applied into the inlet portion of 7. Conversely, the velocity of the fluids from the outlet portion of 10 is greatly increased by the electrically excited electrodes located in the discharge portion 10 prior to being introduced into the inlet portion of 8. The strong suction force referred to above for discharge portion 9 applies to its counterpart 10. In the case of FIG. 2, the recirculating ionic generated fluid-force is utilized to augment the fluid velocity of its opposite turbine counterpart. The electrodes 14 and 15 illustrated in FIG. 2 have needle-like pointed ends. Electrical discharges from pointed electrodes cause a preponderance of ions to be produced, and having the same polarity charge as the electrodes. An extremely large gradient potential is present in the vicinity of the sharp electrode points, and any charged particles with the same polarity as the charged electrode will be rapidly pushed away from that electrode, and conversely, any charged particle with an opposite polarity of an electrode will be very strongly pulled toward that electrode. By alternating the polarity of the electrodes, the charged particles are alternately pushed and pulled between the rows of electrodes. In the event that some of the ions in the moving fluid stream accidentally collide and experience a polarity change far from away from the sharp-pointed electrodes, the ion(s) whose charge is different form that of the rest of the ionic pulse will be rapidly neutralized by recombining with the oppositely charged ions in the pulse and therefore will not appreciably affect the net flow or velocity of the fluid.

The internal walls of the fluid-force generators are provided with electrodes placed in rings; these electrode rings are positioned in groups with increasing spacing of the electrodes in each group in the portion 88 toward the constricted area, and decreasing spacing in each group in portion 89 on the discharge side of the constricted area. Two groups of electrodes are shown at 90 and 91 in the inlet area of wind generator 2a, and two additional sets 92 and 93 are illustrated in the cut-away portion. The latter portions 92 and 93 show the progressive spacing of each sectional area.

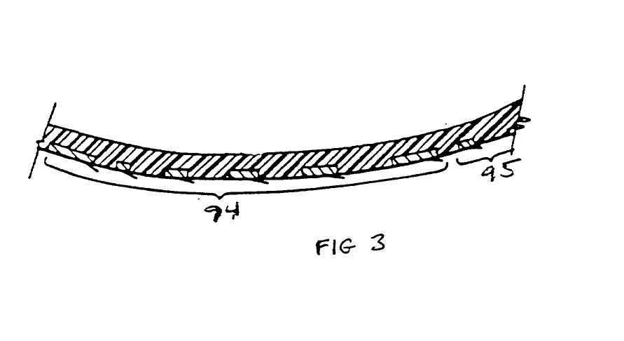

FIG. 3 illustrates a set of electrodes 94 and a portion of the set 95. It will be noted that the electrodes are pointed in the direction of fluid flow. The spacing of the electrode elements of each ring groups increases as the section of the force-fluid generator decreases; after passing the constricted area the spacing decreases as the force-fluid generators cross sectional area increases. The numerous sections of the electrodes excitation system may be separately excited and connected to different power supplies with different frequency alternating current systems so that the resonant velocity of the fluids passing over the electrodes may be increased over the force-fluids generator's constricted throat area, and decreased thereafter. Therefore, the flow rate of the fluids along the inner walls of the force-fluid generator may be controlled by changing the frequency of the alternating potential impressed on one group with respect to that of the next. In order to maintain the flow through the force-fluid generator at the desired high velocities, and at the same time with minimal turbulence, the rate of flow of the fluid is varied generally in inverse proportion to the cross sectional area; for an application such as the force-fluid generator, the rate of flow is controlled so that the product of the cross sectional area and the velocity of the fluid is substantially constant at all points along the force-fluid's generator. In some applications it is found to be advantageous to progressively decrease the product of the flow velocity times the cross sectional area along the flow path through the force-fluid generator. By proper adjustment of the power supply, fluid such as air may be caused to flow at high velocity through the constricted throat area of the force-fluid's generator with a minimum of turbulence.

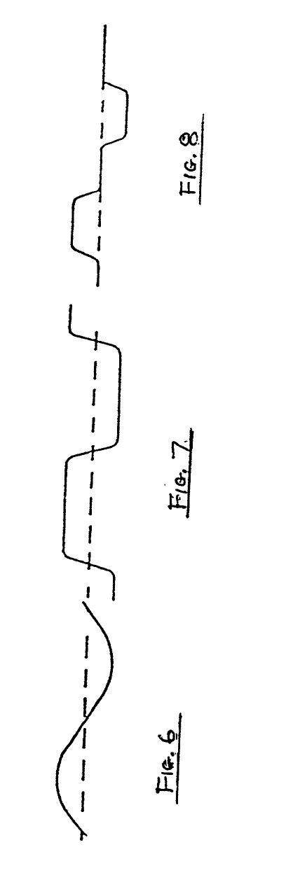

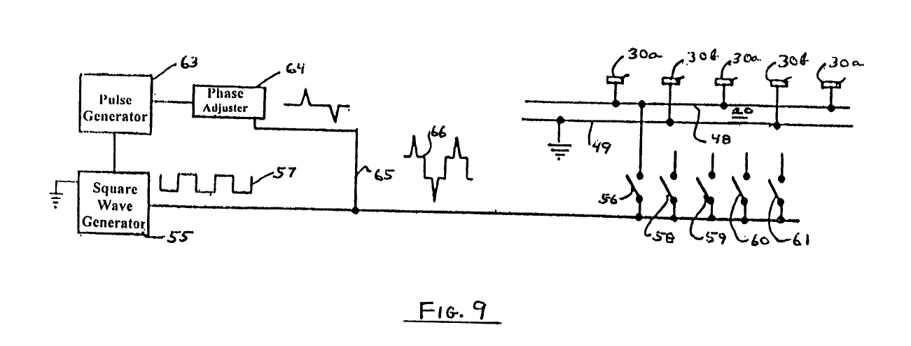

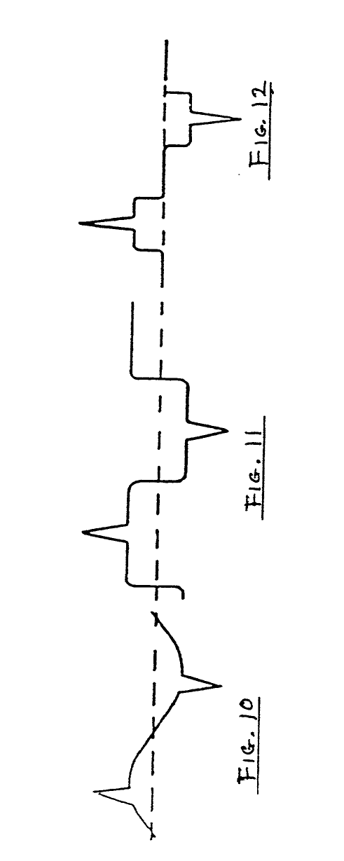

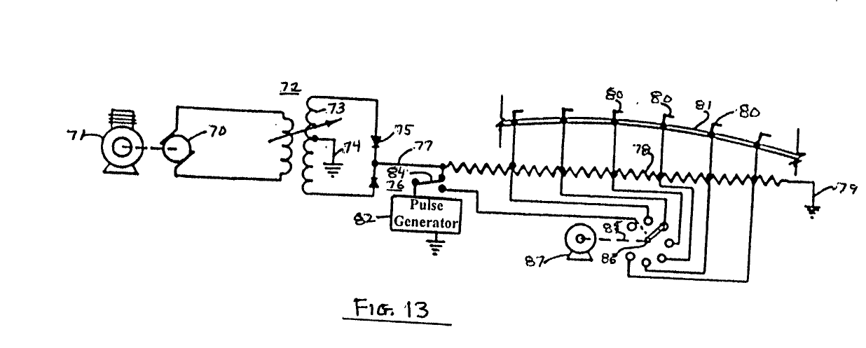

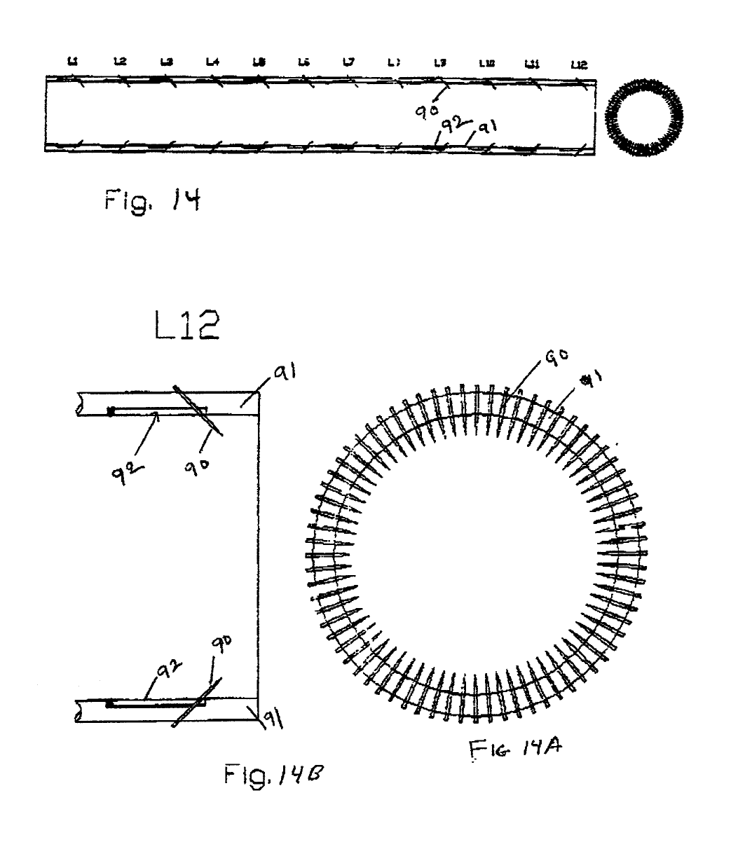

FIG. 4 is a side view of the force-fluid generator as indicated in FIG. 2, and it will be noted that the numbering system for the components of FIGS. 2 and 4 are identical except for the electrodes 14 and 15 are not visible in the side view of FIG. 4. Also not shown in either of the figures are the stationary side plates and bearing mechanisms that hold the paddle-wheel turbine in place and allow it to rotate when under pressure from the fluids of the generators.

FIG. 5 illustrates the paddle-wheel-turbine blades 13, the stationary fixed side plates 52, the caps 53 for the bearing mechanism, the shafts 51 that can be common to both sides of the paddle-wheel turbine 50, or can be operated independently if different shaft speeds are required for dissimilar functions; for example two unlike power generation equipments with different shaft speed specifications could be simultaneously operated from the same paddle-wheel turbine by providing gear boxes for shaft speed control. The number of turbine blades 50 will also change with variations in applications; a power generator will likely require more blades than a farmer's water pumping system.

Three different wave forms are indicated in FIGS. 6, 7 and 8. The wave form of FIG. 6 is essentially a sine wave and it will be noted that the duration of the portion of the wave when the voltage is substantially zero is very short; a pulse of this form, however, may be employed when the electrode has substantial width in the direction of fluid flow, thus placing a substantial portion of the moving ions over a near zero potential gradient zone during the change-over of electric field direction. Also, this sine wave form can be used without this objection and without these wide electrode configurations in some multiphase traveling wave systems.

The square wave form of FIG. 7 has an advantage of maintaining higher potential for a greater portion of the cycle and makes possible the imparting of greater energy to the masses of moving charged particles. In view of the abrupt change from one square wave peak to the other, it is desirable to provide a substantial width of electrode strip over which the charged particles can coast in a near zero electric field while the field between electrodes is changing direction as in the case of the sine wave FIG. 6.

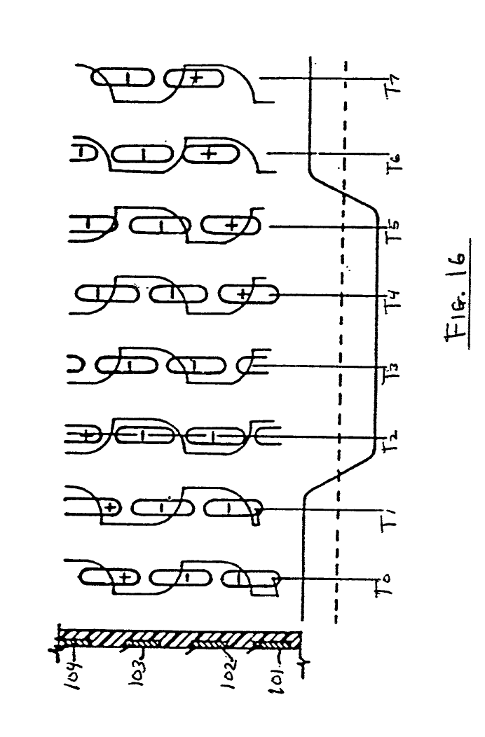

In the wave form of FIG. 8 the square wave portion is followed by a substantial portion at zero potential before the reverse in polarity. This overcomes the disadvantages of the other wave forms when used in single phase excitation systems by providing a substantial period during which the electrodes are neutral giving a zero electric field. This affords ready passage of the ions across the electrode without reversed propulsion on the ions arriving before or after the electric field reversal. A high voltage or ionization pulse may be impressed on any of the wave forms of FIGS. 6, 7 and 8 and the resulting wave forms are indicated in FIGS. 10, 11 and 12, respectively.

FIG. 9 illustrates the form of an excitation system that provides short duration high amplitude pulses superimposed on the alternating wave form to effect periodic higher intensity ionization of the fluid adjacent the electrodes. In this system a square wave generator 55 is connected to the line 48 through a switch 56 and impresses a square wave on the electrodes as indicated at 57. The other side of the square wave generator 55 is connected to the ground terminal as indicated, and the bus bar 49 is also grounded so that the electrodes 30b are connected to the opposite side of the generator. The square wave form 57 is thus impressed between the alternate electrodes in the same manner as the alternating potential would be impressed on the electrodes of any circuit of this invention. Additional electromechanical switches 58, 59, 60 and 61 are provided for connecting other groups of electrodes to the generating system. Electronic switches may be substituted for electromechanical switches as indicated in 58a, 59a, 60a and 61a. In order to effect ionization of the fluid adjacent the electrode, short pulses at the same frequency as the generator 55, but of greatly increased potential are impressed on each of the half cycles of the wave produced by the generator 55. In order to produce these pulses, a pulse generator 63 is connected to the generator 55 for synchronism therewith and, is connected through a phase adjuster 64 and a line 65 to the switch 56 (or 56a) so that the ionization pulse is impressed on the electrodes with the square pulse 57. The timing of the ionization pulse with respect to the square pulse may be effected by adjusting the phase adjuster 64 so that the most desirable ionization is effected by corona discharge during each half cycle. The resulting composite wave form being indicated at 66 and being the wave form occurring on the supply line connecting the generator 55 and the switches after the ionization pulse has been impressed on the line through the connection 65.

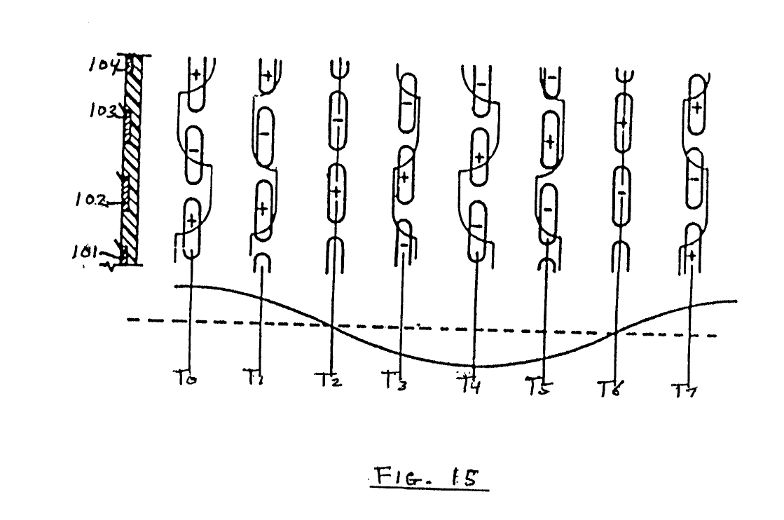

The high voltage or ionization pulse may be impressed on any of the wave forms indicated in FIGS. 6, 7 and 8 and the resulting wave forms are indicated in FIGS. 10, 11 and 12, respectively. The wave form of FIG. 11 is the same as that indicated at 66 in the schematic diagram FIG. 9.

A high voltage direct current excitation system is suitable for the excitation of the electrodes in some applications of the invention, and an example of such generating and excitation system is schematically illustrated in FIG. 13. In this figure an alternating current generator 70 driven by either an internal combustion engine 71, or a solar power energy source as indicated by 71a, is connected to the primary of a transformer 72 and the secondary of the transformer, indicated at 73, is connected to supply a full wave rectifier. The center tap of the transformer is connected to ground as indicated at 74 and the two terminals are connected through rectifiers 75 and 76 to a common output line 77. Direct current thus appears at the output and the system is arranged to generate a high direct current voltage across a voltage dividing resistance 78 between the output 77 and a ground connection 79. The resistance 78 is tapped at intervals and the taps are connected to a plurality of electrodes 80 mounted in a surface 81. It will be apparent that if the tapping arrangement is provided with equal taps the full voltage produced by the generator 70 will be divided equally so that the electrodes will be at progressively higher potentials in equal steps.

In the operation of this system the charged particles adjacent each of the electrodes 80 and having the opposite polarity are attracted toward the next electrode because of its higher potential, and a large portion of the particles will similarly move past the electrodes in succession because of the steadily increased potential of the electric field. FIG. 13 also illustrates the electrodes as mounted on a convexly curved surface; with this surface configuration, as the ions are moved from one electrode toward the next they are also drawn around the curved surface and this surface introduces centrifugal force in the particles and provides a force normal to a surface producing lift such as required on mineral classification systems.

In order to provide an increased supply of charged particles in the system of FIG. 13, a high voltage pulse generator 82 is connected to the lead 77 to introduce periodic high voltage pulses across voltage divider 78. These pulses are of short duration but of sufficient potential to produce corona discharge and thereby provide a supply of ions for operation of the system.

Under certain applications of the system of FIG. 13 it may be desirable to apply the ionization pulses to successive electrodes along the line of electrodes rather than impressing the ionization voltage on the first electrode in the series. In order to secure this successive application of ionization voltage, an electro-mechanical switch 84, or an electronic switch 84a, is provided between the generator 70 and the voltage dividing resistance 78. When this switch is moved to its lower position it connects a rotary switch or commutator 85 to the pulse generator 82. The switch 85 includes an arm 86 which is rotated by a motor 87 and engages successively each of a series of contacts arranged about its circumference and connected respectively to successive ones of the electrodes 80. The connections as illustrated are made at the same points of the divider resistance as to which the electrodes are connected. It will be seen that as the switch 85 is rotated in a clockwise direction it connects the electrodes one after another in succession to the pulse generator 82, so that ionization pulses appear at successive masses of ions by corona discharge along the path of fluid flow.

FIGS. 14, 14A and 14B illustrate another embodiment of the present invention that can be utilized with the power supply of FIG. 1. FIG. 14 represents a cutaway-side view of a linear force-fluid-flow-tubular generator that has no insulated curved interior surfaces or narrow throat area as previously shown in FIGS. 2, 3, 4 and 5. FIG. 14 illustrates an example of how the electrodes can be positioned in an insulated housing to effectuate a fluid flow of ions when the electrodes are provided with electric excitation. The upper row of electrodes shown in this diagram are designated L1 through L12, and thus represent the number of electrodes present in a twelve phase system. FIG. 14 is also different than FIGS. 2 through 5 in that these diagrams show that when a constricted throat area is employed in an insulated housing, the electrode spacing must be increased as the diameter of the cross-section decreases and decreased when the dimensions of the cross-section increases. The electrodes of FIG. 14 can be positioned in equidistant spacing as long as the desired velocity of the operating fluid does not get too high. If high velocity fluids are required the electrode spacing must be increased if resonance is to be achieved for the overall system.

FIG. 14A is a diagrammatic end-view of the force-fluid-flow generator that shows a multiplicity of sharp-pointed electrodes 90 positioned around the perimeter of the generator's insulated tubular housing 91. It will be noted that these sharp-pointed electrodes 90 are positioned in a very close proximity to each other, and form a ring of sharp-pointed electrodes that when electrically charged produce an enormous quantity of charged ionic particles having the identical polarity charge as the emitting electrode. This commonality of electrically charged ions and electrodes prohibits any unwanted interaction between them, but instead promotes the desired reaction of the electrodes repelling the ion particles away from the mother electrode, over a portion of the insulator housing, and towards the next ring of electrodes that have the opposite polarity, and thus are attracting the oppositely charged particles.

FIG. 14B presents a close-up view of the sharp-pointed electrodes of FIG. 14 and illustrates one way the electrodes 90 can be installed in an insulator housing 91. It will be noted that the pointed electrodes are positioned in insulator housing 91 and also in electrode bars 92. Electrode bars 92 may have a plurality of configurations; the one illustrated here are of a flat-bar type. The electrode bars 92 serve a number of important functions; one is to provide the electricity required to charge to pointed electrodes in each one of the electrode rings that make-up a fluid-force generator, and another purpose is to provide an extra conductive area so that sufficient corona is created to permit the generator to fulfill its purpose, and finally the electrode bars assure that the correct positive or negative charge is provided to all of the electrodes in a given ring of electrodes in a correctly timed manner.

When alternating current excitation is employed, the ions or other charged particles are accelerated to successively higher velocities by increasing the voltage gradient until they reach a resonant velocity with respect to the alternating frequency. The resonant frequency is determined by the relationship f=V/D where f equals the frequency in cycles per second, V is the charged particle velocity in centimeters per second and D is the minimum distance in centimeters per second between electrodes which have electric potentials of the same phase relationship. The desired velocity V can be obtained by varying the average accelerating voltage gradient between electrodes within certain limits required to maintain the desired degree of ionization. The frequency can then be adjusted to obtain resonance with resulting charged particle velocity V and the minimum distance D between electrodes having the same phase relationship. Proper resonance can be obtained by varying either the voltage gradient within prescribed limits or the frequency. Frequencies in the range from 60 cycles per second to 33,000 cycles per second are desired for many electrode configurations and spacing, but higher or lower frequencies may be needed for resonance in other systems. The distance “D” between electrodes having the same phase relationship may be of the order of one inch up to sixty-six inches for many embodiments but larger or smaller distances may be used in some applications. The actual spacing between adjacent electrodes is often in the order of one-half inch to six inches but may be made larger or smaller in some applications. Voltages of the order of 1,000 volts to 500,000 volts may be applied between adjacent electrodes and total peak to peak alternating voltages of the order of 5,000 volts to 750,000 volts may be applied between electrodes having a 180 degree phase difference, but in some applications larger or smaller voltage differences may be used. If the average accelerating voltage gradient needed to obtain the desired resonance velocity V is too low to produce a corona discharge then the short high voltage pulses are impressed on the alternating potential pulse to obtain the desired ionization by corona discharge.

When direct current excitation is used the charged particles are accelerated to a velocity determined in part by the voltage gradient, the average concentration of charge on each particle, the concentration of charge particles, and the viscosity of the air or other fluid medium. Each electrode element is at a higher potential than the preceding element of the series.

FIGS. 15, 16 and 17 illustrate the characteristics of the excitation systems employing the alternating potential wave forms of FIGS. 6, 7 and 8, respectively, when operating at resonant velocity in conjunction with one form of electrode element. In the description of these systems the characteristic curves indicated have not included the ionization pulses that may be used in some applications if the desired accelerating voltage wave is not adequate to produce the desired intensity of ionization. In each of these figures four of the electrode elements designated 101, 102, 103 and 104 are indicated along the left end of the figure followed by a succession of eight vertical voltage-distance curves each showing the potentials of the four electrodes and the position of masses of positive and negative charged particles propelled by the electrodes. The eight curves represent the voltages and the positions of the charged particles at eight equally spaced instants of time during a full cycle of the excitation wave. The excitation waves for the electrodes 101 and 103 have been indicated in each of FIGS. 15, 16 and 17 along the lower portion of the figures on a time base. The eight positions indicated are taken at instants of time designated t0 to t7, inclusive, along the excitation wave. The excitation wave for the alternate electrodes 102 and 104, which is not shown, is identical in form but 180 degrees out of phase with the excitation wave shown. The electrodes 101 and 103 thus correspond to electrodes 30a in the previous diagrams and the electrodes 102 and 104 correspond to electrodes 30b. Alternate masses of charged particles are positively and negatively charged, respectively, as indicated in FIGS. 15, 16 and 17. Although the charged particles within each of the masses or clusters repel each other and tend to diffuse outwardly, these masses remain substantially intact as they are propelled past electrodes 101, 102, 103 and 104.

FIG. 15 illustrates the resonant velocity characteristics when the electrodes are excited by a sine wave form as shown in FIG. 6. The first curve at the right of the electrodes and designated t0 represents the instant when the excitation wave on electrodes 101 and 103 is at its maximum positive potential and electrodes 102 and 104 are maximum negative. The electric field potential curve plotted against the distance along the series of electrodes comprises flat portions of the length of the electrodes and sloping portions connecting the positive and negative potential value of the adjacent electrodes. The wide electrode consisting of electrically conducting material causes the electric field potential to remain essentially constant over the width of the electrodes, thereby producing the flat portion of the curve. At the instant t0, the positive charged particles are moving from 101 toward 102 and from 103 toward 104 along a decreasing potential field, and negative charged particles are moving from 102 toward 103 along an increasing potential field. The mass of positive charges is attracted toward the negative electrode and repelled from the positive electrode and the mass of negatively charged particles is attracted towards the positive electrode and repelled from the negative electrode. At the end of the interval of time between t0 and t1 the masses of particles have moved to their positions shown in curve t1 and it will be noted that the potentials of the electrodes have been reduced to the value at t1 on the excitation sine wave extending along the lower portion of the figure. The particles continue to move and at the instant t2 they are in the position shown in the curve t2. At this instant the potentials are zero on all electrodes and the polarity of the electrodes is about to change. In the next curve at time t3 the potentials of the electrodes and the direction of the electric field have been reversed to give the values shown in curve t3, the electrodes 101 and 103 being negative and the electrodes 102 and 104 positive. The positive charges which were propelled from 101 toward 102 at the instant t0 are now adjacent to, or past, 102 and are being propelled from 102 towards 103 by this reversed electric field. Likewise, the negative charged particles which were propelled by the electric field from 102 towards 103 at the time t0 will now have moved to a position above or past electrode 103 and the reversed electric field will propel them from 103 toward 104. The potentials continue to increase with time along the sine wave excitation curve until at the time t4 the electrodes have opposite potentials of equal magnitude to those shown at t0. The progress of the masses of charged particles may be traced through successive increments of time to t5, t6, t7 and return to t0 on the curves labeled accordingly. It will be noted that the electrodes excited in this manner are electrically analogous to the loops of a standing wave with the nodes of the analogous standing wave being located between the electrodes. When this excitation system has the proper relationship between accelerating voltage, electrode spacing, and frequency such as to propel the masses of charged particles at the correct velocity to always pass over each wide electrode as it changes polarity and enters the electric field between each pair of electrodes when that field is oriented in the direction to further accelerate the charged particles movement, then resonance conditions are established.

This periodic kick, or acceleration, given the charged particles as they are propelled through the electric field between electrodes when resonance conditions are established produces what is called the “traveling wave effect.” This means that the charged particles are progressively propelled along the desired flow path giving a propulsion effect similar to that of a traveling wave.

It should be noted that under most conditions more negative ions are produced by the corona discharge than positive ions. The higher concentration of charges in the mass or cluster of negative ions will cause it to accelerate more rapidly then the masses of positive ions. When this unbalanced condition exists, the system should be tuned for resonance with the dominant mass of negative ions.

FIG. 16 shows the same electrodes as those illustrated in FIG. 15 but with a square wave excitation impressed on the electrodes. In the square wave form as illustrated at the bottom of FIG. 16 the portion passing through the zero potential located between maximum positive and maximum negative is relatively short and steep and the time intervals have been selected so that all the instants t0 through t7 are at maximum potentials. The operation of the system moving the positive and negative charged masses is essentially the same, however, and can be followed in the same manner. The first two time intervals t0 and t1 occur during the first positive flat top portion of the wave, and the polarity of the wave changes during the period between t1 and t2 thereafter t2, t3, t4 and t5 are all instantaneous times during the flat portion of the negative going wave. This is then followed by t6 and t7 occurring at instants during the following positive portions of the wave, and t0 is then repeated as the start of the next cycle. It will be understood that these positive and negative portions of the wave have reference to the excitation of the electrodes 101 and 103 and that the electrodes 102 and 104 which are connected to the opposite side of the generator are at opposite potentials. When the proper relationship is established between the accelerating voltage, electrode spacing and frequency to achieve resonance, then the “traveling wave effect” will propel each of the masses of charged particles progressively along the series of electrode elements. As a result of the square wave form the masses of charged particles are propelled more effectively in the arrangement of FIG. 16 because the potentials are maximum for a greater length of time in each half cycle as compared with the arrangement shown in FIG. 15. Some improvement may be obtained by decreasing the magnitude of the excitation voltage wave to a value lower than that required for ionization and then superimposing a higher voltage ionization pulse or series of pulses over a portion of each half cycle of this wave.

In order to decrease still further the loss of ions by capture or neutralization, an excitation arrangement such as shown in FIG. 17 may be employed; in this arrangement a flat top wave form is used which has a period of zero potential between the positive and negative flat top portions of the waves. In FIG. 17 at the instant t0 the masses of particles are in essentially the same positions and the electrodes are the same potential as in FIGS. 15 and 16. From t0 to t1, the electrode potentials remain unchanged but the particles have moved forward toward the next adjacent electrodes; the potential thereafter changes to zero, and during the subsequent period including the instants t2 and t3 the potential remains at zero while the masses of charged particles coast forward. Between t3 and t4 the polarities of the several electrodes are reversed, as shown in curve t4; masses of positive charges are now being attracted toward the electrode 101 and 103 that now have a negative potential and masses of negative charges in a similar manner being attracted toward electrodes 102 and 104 and repelled by the opposite electrodes. On passing from time t5 to t6 the polarities again fall to zero and are maintained as zero during the subsequent period including the instants of time t6 and t7, after which they are again reversed and return to the same polarities as at t0.

It will be apparent from the foregoing that the movement of charged particles over a series of electrodes as indicated in FIGS. 15, 16 and 17 may be controlled by controlling the configuration and width of the electrodes and by controlling the wave form of the exciting potential.

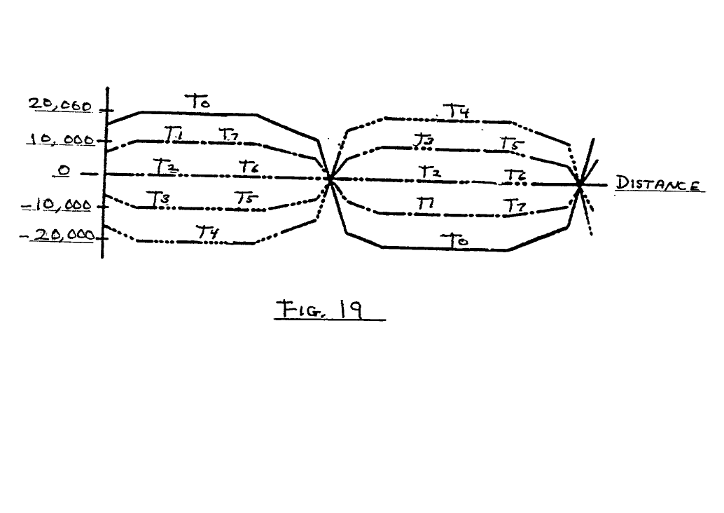

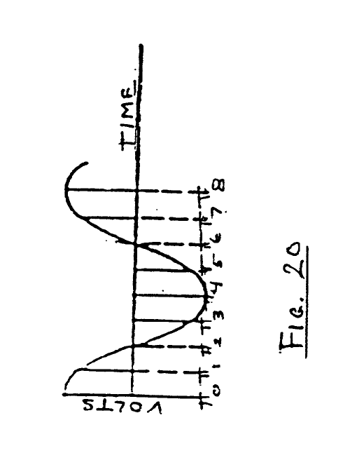

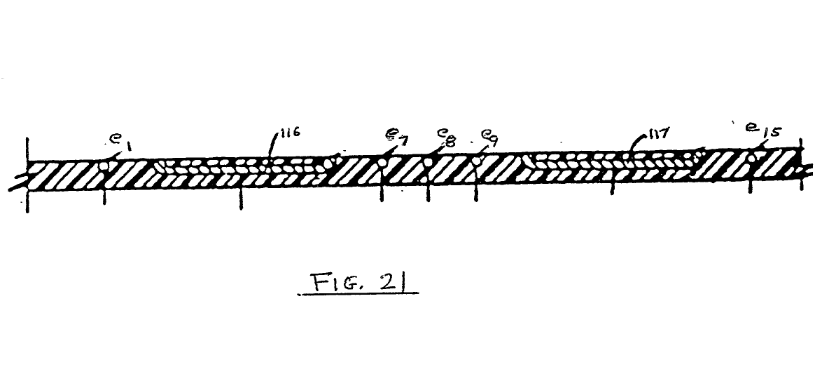

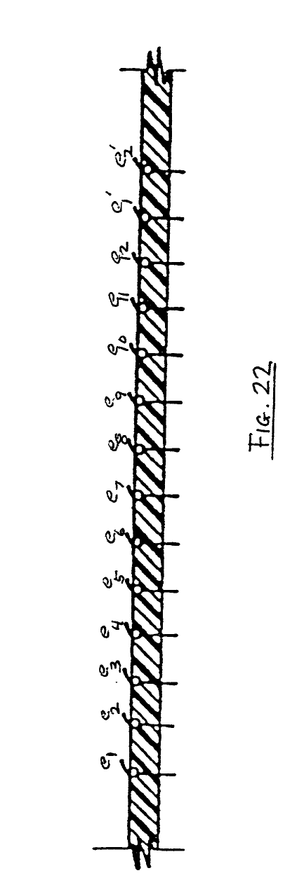

The electrode excitation system shown in FIG. 18 employs an alternating current transformer 106 having a primary connected to a suitable source of alternating current and a step-up secondary 108 which is tapped and has its output terminals connected to a series of electrodes indicated as e1 to e10, inclusive; these electrodes have been indicated as of circular cross section with corona discharge points facing toward the right. The two end terminals of the secondary winding 108 are connected to two separate groups of electrodes, the first terminal indicated at 109 being connected to the electrodes e2 through e6, and the other terminal indicated at 110 being connected to the electrodes e10 through e11. All of the electrodes within each of the respective groups are thus maintained at the same potential during the operation of the system, this potential being the alternating potential at the respective end terminals of the transformer secondary. Six variable taps are employed in the secondary as indicated at 111, 111a, 112, 113, 114 and 114a; the taps 111 and 111a are connected to the electrodes e1 and e7 respectively, and the taps 114 and 114a to electrodes e9 and e15 respectively. The inner taps 112 and 113 are connected, respectively, to the electrodes e8 and e16. It will be seen that the connections provide two main groups of electrodes one from e1 to e8 and the other from e9 to e16. During the operation of the system the alternating potential varies so that in a complete cycle the electrodes of the first group vary in voltage from a maximum positive voltage to a maximum negative and back to maximum positive, while the electrodes of the second group vary in exact opposite phase from the maximum negative voltage to a maximum positive and back to a maximum negative. This variation in potential along the series of electrodes at eight instants of time during each cycle is illustrated as curves marked t0, t1, t2, t3, t4, t5, t6 and t7 on the illustration FIG. 19. In these curves, the distance along the electrode line of 18 is plotted along the x-axis and the voltage is plotted along the y-axis. The voltage wave form used in this example is shown as a graph of voltage against time in FIG. 20. The instants of time t0 through t7 and back to t0, and the corresponding voltage applied to electrodes e2 to e8 are indicated on this graph. In some applications, other wave forms can be used advantageously. In the circuit FIG. 18 it will be noted that the first electrode e1 is connected to the tap 111 so that its voltage is below maximum at the instant t0 when the voltage on the electrodes e2 through e8 is maximum. Following the curve of voltage against distance at the instant t0 in FIG.19, it will be noted that the group of electrodes e2 through e6 is at a maximum positive potential, and that electrodes e1 and e8 have successively lower positive potentials. Electrode e9 has a negative potential and electrodes e10 through e14 has successively less negative voltage; the next electrode in line (not shown) would have the same potential as e1. As the voltages fall to the values at t1 in the graph FIG. 20 the curve t1 represents the voltages along the electrode line, all of which are, of course, less that the voltages at t0. The voltages then continue to fall to the point t2 at which time the curve of FIG. 20 reaches the zero axis and the electrode potentials are represented by the center or reference line of FIG. 19. The voltages then become negative on the first group of electrodes e1 to e8, and positive on the second group e9 to e16 and increase until the time t4 when the voltages represented by the curve t4 are the maximum negative voltages for the first group of electrodes and the maximum positive for the second group. The voltages then reverse again so that the voltages at the instants of time t5, t6, and t7 are respectively the same as those existing at t3, t2 and t1, but the direction of the voltage change with time is opposite. Finally, the voltages return to their values at t0. It will be noted that this excitation system provides an arrangement whereby the voltages in one group e1 through e8 are changing with time oppositely with respect to voltages of the second group e9 through e16. The zero voltages at all times occur between the electrodes e8 and e9 and between the electrodes e16 and the next electrode (not shown). A similar zero point exists at the left end of the graph that has not been illustrated. This system thus provides an alternating potential excitation along the series of electrodes which is analogous to a standing wave where the electrode groups e2 through e6 and e10 through e14 are electrically comparable to standing wave loops and the nodes occur between electrodes e8 and e9 at approximately time t0 and between e16 and e1 of the next series. By way of example, a mass of positively charged particles coasting through the nearly zero potential field above the group of electrodes e1 through e8 and emerging into the electric field from e6 to e7 to e8 to e9 to e10 will be given a kick, or acceleration, toward the right along the electrode line by this high electric field strength. As the charged particles pass electrode e10 they enter a near zero potential field extending from e10 to e14 where they can coast with essentially no electrical forces. If the system is tuned for resonance, the direction of the electric field will be reversed (time t2 to t3 ) by the time the first portion of the mass or cluster of positive charged particles emerge from the zero potential field between e10 and e14 and enter the electric field between e14 and e2 of the next electrode series (not shown). From time t3 to t5 the mass of positive charged ions will pass through this electric field from e14 through e2 and then coast through the zero field area above the electrodes e2 through e6 of the second series of electrodes. During this same interval of time from t3 to t5 a mass or cluster of negative ions will be kicked or accelerated through the electric field from e6 toward e10; and in subsequent time they coast through the near zero electric field area from e10 to e14. If some of these negative ions arrive at e14 slightly before the electric fields are reversed at time t6 they will enter an adverse electric field beyond e14 which will slow down the high speed lead ions and cause them to be bunched together with the rest of the main cluster or mass of ions. The proper adjustment of the tap positions 113, 114, 111 and 112 can shape the electric field to facilitate clustering these ions into a higher concentration, and thereby minimize diffusional losses. Also the length of the coasting path between e2 and e7 and between e10 and e14 can be adjusted to minimize losses and to achieve improved performance.

If the quantity of negative ions produced by the corona greatly exceeds the quantity of positive ions, then the system should be tuned predominantly for resonance with the masses or clusters of negative ions. Resonance is achieved when the excitation voltage, the distance between electrodes, the number of electrodes in a complete cycle and the frequency are adjusted so that each mass or cluster of ions emerge from the coasting area into the strong electric field area at the proper time to receive a kick, or acceleration, in the direction of the desired flow along the series of electrodes. When this resonance is achieved, then the resulting “traveling wave effect” will propel each of the masses of charged particles progressively along the series of electrode elements.

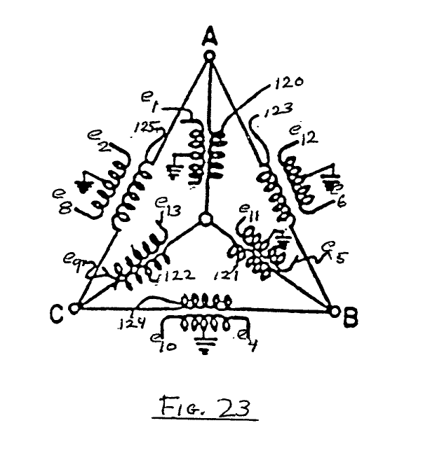

FIG. 21 illustrates a modified arrangement of the electrode line of FIG. 18 and provides an arrangement whereby the group of electrodes e2 through e6 and e10 through e14 are replaced, respectively, by continuous bar or strip electrodes 116 and 117; the remaining electrodes are the same as those in FIG. 18 and have been designated in the same manner e1, e7, e8, e0, e15 and e16. These electrodes act in the operation of the system in the same manner as the corresponding group of electrodes in FIG. 18. These strip electrodes are formed with rounded left and right end portions similar in configuration to the electrodes of FIG. 18, and which are connected by a body portion of a thickness less than the diameter of the rounded portions and providing a flat generally convex area on the upper sides of the electrode. These areas are filled or coated with plastic or other insulating material that may be the same as that which surrounds the electrodes and thus provide two exposed electrodes in conducting relationship and separated by an insulating area. During the operation of the system a portion of each of the masses, or charged particles, moving over the electrodes 116 and 117 collects on the insulated surface between two end portions and after a certain amount of electric charge has accumulated. The resulting electric field intensity prevents additional ions from striking this surface and thereby minimizes the loss of charge from the mass of particles. This surface charging effect on the insulating surface over each electrode element, of course, occurs during each half cycle and represents a small continuous loss during operation of the system. This loss is calculated to be in the order of 20 to 80 watts per square foot of area. However, this loss is less than that occurring when the entire surface of the electrode is of conductive material, in which case the charges reaching the electrode surface are conducted through the voltage generating system and do not build up a counter potential. The electrodes 116, furthermore, are constructed so that the first rounded portion or rear edge of the electrode is smooth while discharge points are provided at the forward end, these points are in the form of rows of points constructed in the same manner as described in connection with the previous illustrations.

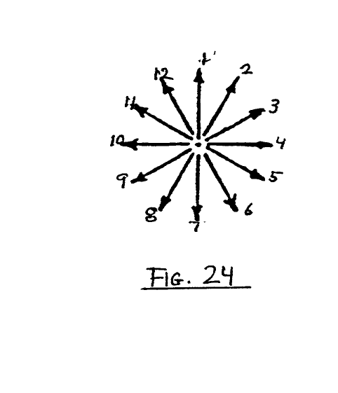

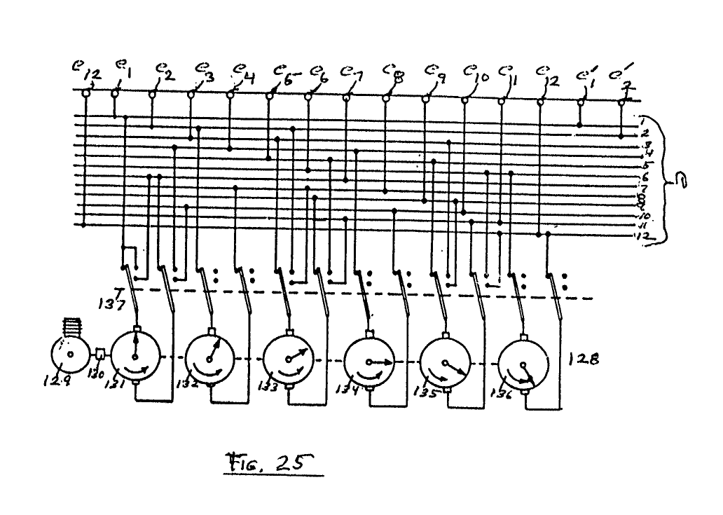

FIGS. 22, 23 and 24 illustrate another excitation system embodying this invention. FIG. 22 shows a line of electrodes numbered e2 through e12 and then repeating e1, e2 and e3, this being a portion of a continuous repeating pattern of twelve electrodes. The excitation transformer connections for this line of electrodes are indicated in FIG. 23, and comprise an arrangement such that the successive electrodes from 1 through 12 are excited at equal phase differences of the alternating potential. The phase difference between the electrodes is indicated in FIG. 24 where the potential of each of the electrodes is indicated by a vector bearing the designation of its respective electrode. The excitation system for the line of electrodes comprises a network of transformers, three connected in star and three in delta to the three terminals of a three phase source; these terminals are indicated at A, B and C. The voltage wave on each of these terminals is 120 degrees out of phase with that of each other terminal. The primary windings of the transformers are connected in this star-delta arrangement, the three primary windings of the star connection being designated 120, 121 and 122 and those in the delta connection 123, 124 and 125. The end terminals of the transformer secondaries are connected to the electrodes and the terminals of these secondaries have been indicated by the designations of the electrodes to which they are connected; thus electrodes e1 and e7 are connected to the transformer 120, e5 and e11 to 121, e4 and e3 to 122 and in a similar manner e12 and e6 are connected to 123, e10 and e11 to 124, and e8 and e3 to 125. The center taps of each of these secondary windings are grounded. This connection provides an arrangement whereby each of the two electrodes connected to any one of the secondaries are at opposite potentials at any instant of time during the alternating current cycle and the connections as shown are further arranged so that the successive electrodes e1 through e12 are at 30 degrees phase difference and provide successive potentials from the line of electrodes. By this arrangement electrode e2 lags 30 degrees behind e1 and electrode e3 lags 30 degrees behind e2 and so on through the series of electrodes. This moves the charged particles along the electrode line at a rate determined by the frequency of the alternating potential and by the spacing between the electrodes. This arrangement thus provides an electric field along the line of electrodes that is in the form of a true traveling wave. The velocity of the traveling wave is V=f×d where V is the velocity in cm./sec., f is the frequency in cycles/sec. and d is the distance in centimeters between electrodes of the same phase. These units can also be measured in feet/sec., cycles/sec., and feet per cycle, respectively. When the excitation voltage and frequency are adjusted so that when the charged particles are propelled along the surface at the same velocity as the traveling wave, resonance is achieved. This high velocity flow of charged particles and the induced surface layer flow of the ambient fluid over a device's surface reduces the fluid pressure on the surface area of the device.

FIG. 25 is a schematic diagram illustrating another embodiment of the invention wherein the excitation system produces a traveling wave along the electrode line and illustrates further an electromechanical switching arrangement for changing the velocity of the traveling wave and consequently the resonant velocity of the charged particles moving along the line of electrodes. This switching means for changing the velocity of the charged particles and the ambient fluid flow is used in conjunction with variations of frequency is a controlling device for the velocity of the ambient fluid. In FIG. 25 the line of electrodes comprises groups of electrodes designated e1 through e12 and these electrodes are connected to be excited by a multiphase generator 128 driven by an external power source such as an engine or a solar power source 129 and 129a through a speed changing transmission 130. The generator 128 comprises six generating elements designated 131 through 136, inclusive; these generator elements are operated so that they produce alternating current potentials which are successfully 30 degrees out of phase, this phase difference being indicated diagrammatically in the figure by the position of the arrows on the respective generating elements. The rotation of this vector arrow is counterclockwise which means that the voltage on e2 lags 30 degrees behind the voltage on e1, e3 lags 30 degrees behind e2 and so on through the series of electrodes. The voltage wave on the lower terminal is 180 degrees out of phase with the voltage on the upper terminal. Therefore, the lower terminal of the generator element 131 is connected to electrode e7 while the upper terminal is connected to e1 and so on through the series of generator elements. The terminals of the generating elements, as illustrated as mechanical switches, are connected to pairs of switch blades all of which are assembled as a gang, or unit, actuated by a common mechanism indicated generally by the dotted line 137. In their left hand positions as shown in the figure these switches connect the top terminals of the generators 131 through 136, respectively, to the electrodes e1 through e6 and the bottom terminals, respectively, to the electrodes e7 through e12. The connections between the generators and the electrodes are made through a cable 138 the separate wires of which are indicated by the same designation as the electrodes to which they are connected.

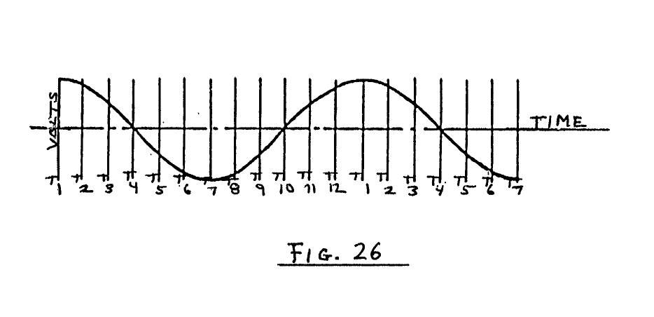

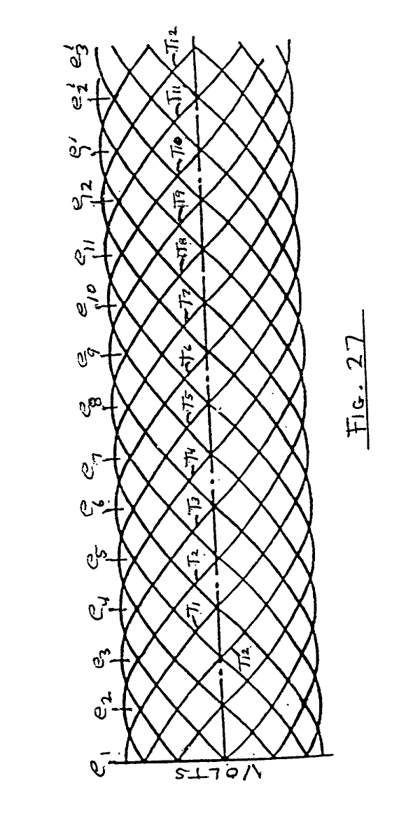

FIG. 26 is a graph showing the alternating potential wave form of generator element 131. This wave has for purposes of illustration, and not by way of limitation, been illustrated as a sine wave; however, for many applications it may be desirable to employ flat top wave forms. The shaped wave may be modified for other applications by the use of high voltage pulses such as indicated in FIGS. 10 and 11. In FIG. 26 a plurality of instantaneous times are indicated for a period including the times from t1 to t12, these being at equidistant points through a complete cycle so that each interval is one-twelfth of a cycle and represents a phase change of thirty degrees. The wave forms for the other generators 132 to 136 are the same except that each successive one in point of time is 30 degrees lagging in phase with respect to the preceding generator.

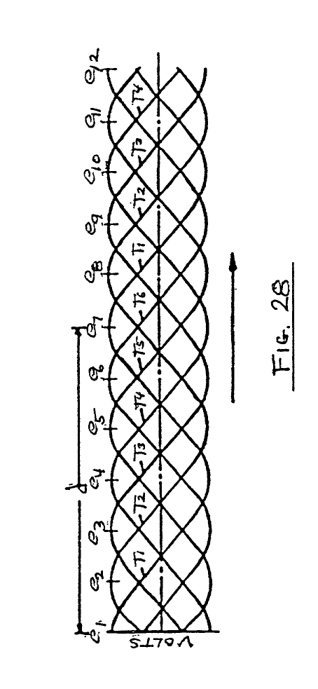

FIG. 27 is a graph showing the change in potential of the electrodes along the line when the switches are in their high speed, or left hand position, as shown in FIG. 25. In this figure the voltage is plotted against distance along the line of electrodes. The figure comprises a plurality of curves at spaced time intervals indicated at t1 through t12. For additional periods the curves repeat because the interval between t1 and the next instant, say t13, represents a full cycle of the potential wave and a curve designated t13 would be identical to the curve t1. The graph FIG. 27 represents the potentials of the electrodes along the line e1 through e12 at each of the instants of time represented by the individual curves. The wave produced by this multiphase system is a true traveling wave and, at resonant velocity, the charged particles move in synchronism with the wave. At time t1 a relative high electric field intensity exists from electrode e2 to electrode e8 causing the propulsion of and, if high enough intensity for corona, the generation of positive ions over this interval. From e6 to e8 the field intensity is relatively low in which the ions which get ahead of their proper position in the traveling wave will coast and tend to slow down. At the same instant of time t1, the high intensity electric field from electrode e8 to electrode e12 will propel negative ions toward the right and, if the electric field intensity is high enough to produce corona, a concentration of negative ions will be created at this interval. If some of these negative ions get ahead of the traveling wave they will enter the low intensity field from e12 to e2 where they will coast and slow down. As the traveling wave moves forward in the next instant of time it will again pick up speed and accelerate these negative ions which got ahead and were slowed down. In this manner, the mass or cluster of ions tend to remain intact thereby minimizing losses. For each successive instant of time t2, t3, t4, t5, etc. the traveling wave advances one electrode spacing In this system the clusters of ions are continuously in the high field intensity portion of the traveling wave and are never in a coasting position. Only the ions which get ahead or behind this high intensity portion of the traveling wave will enter a coasting situation. Those ions getting ahead of the traveling wave will slow down and consequently rejoin the ion cluster being advanced by the traveling wave. A flattening of a small part of the voltage wave crest on each half cycle may be employed to facilitate keeping these clusters of ions together and intact. Furthermore, a small pulse at the leading edge of the flat top portion of each half cycle may be used to provide an extra acceleration for these ions which tend to lag behind the traveling wave and thereby cause them to catch up and join the ion masses being advanced by the traveling wave.

When the voltage is sufficiently high, corona discharge is produced at time t1 over the distance from e2 to e6 and from e8 to e12 which covers two-thirds of the surface area. Only one-third of the area involving the distance from e6 to e8 and from E8 to e12 which covers two-thirds of the surface area. Only one-third of the area involving the distance from e6 to e8 and from e12 to e2 is dead or not used insofar as corona discharge is concerned. At each successive time interval, these areas advance with the traveling wave, but the ratio of about two-thirds of the area involved in corona discharge and one-third in coasting area still remains. This system makes it possible to put a large amount of energy into each unit area of the surface and thus produces a high velocity flow of ions and fluid media with consequent large reduction of fluid pressure.

When the switch operator 137 is moved to the right to connect the switches to the right hand positions, the generator elements 132, 134 and 136 are disconnected while each of the other generator elements has each of its terminals connected to a select pair of the electrodes. Thus the top terminal of the generator element 131 is connected to electrodes e1 and e7 and its bottom terminal is connected to electrodes e4 and e10; the generator 133 has its upper terminal connected to the electrodes e2 and e8 and its lower terminal connected to electrodes e5 and e11; and generator 135 has its upper terminal connected to electrodes e6 and e12.

The right hand portion of switch 137 is the low speed position at which the resonant velocity is reduced to one-half that of the full speed position. The voltage-distance curve for this condition of operation is illustrated in FIG. 28 and it will be noted that the complete cycle takes place at a distance of six electrodes instead of twelve; this is readily apparent when it is noted that the generator elements 131, 133 and 135 are being used and that these generator elements provide voltages 60 degrees out of phase with one another. Thus the resonant velocities for the left-hand and right-hand switching positions provide full and one-half speed, respectively. On the curve FIG. 28 the curves for the instants of time t7, t8, t9 and t10 are identical with the curves t1, t2, t3 and t4, respectively.

When the fluid-force-generation system of this invention is used as a means to drive one or more types of turbines to generate electrical power, the type of discharge from the electrode elements will be controlled by such variables as the electrode spacing, types of electrode materials, the applied voltage pressure, the wave form of the voltage, frequency, pressure, temperature, the impedance of the power supply and the phase angle shifts produced by the power supply. For example, if these parameters are arranged to output a low current discharge under an operating condition like a low ambient pressure, if a greater ambient pressure is applied the low current discharge will tend to increase in intensity and become a visible glowing discharge. Under still other conditions it is certain that an arc-type discharge will occur. When the frequency of the power supply, or one or more of the other variable parameters are changed, the intensity of the corona discharge can be altered to produce various concentrations of ions; depending upon this level of concentration, the physical appearances of the discharge vary from the conventional corona aura, to a glow, and/or various spark-types of visible emissions. All of these discharges are useful in moving ambient fluids.

A copious number of ions of identical charge are produced when any type of discharge takes place from a pointed electrode. Due to the extremely high potential voltage gradient in the vicinity of sharply pointed electrodes, any and all charged particles whose charges are opposite to that of the nearby electrode are very strongly attracted to that electrode where they are captured and neutralized. If some ion pairs are produced far from a sharp-pointed electrode by any means, such as collisions, any ion whose charge is different from that of the rest of the moving pulse will be rapidly neutralized. The ion's neutralization occurs when it recombines with an oppositely charged ion in the specific-directional-moving pulse, and therefore does not appreciably affect the net flow of the fluid.

The fluid flow systems of this invention may be employed for a wide range of purposes wherever it is deemed desirable to provide a laminar flow of fluids adjacent to the application's surface. In applications similar to that described in FIGS. 2 through 5, the spacing of the electrode elements of each ring, or group, is increased as the diameter of the fluid-force generation tunnel decreases; after passing the narrowest end of the throat, the electrode spacing decreases as the cross-sectional area increases. The several sections of the electrode excitation system in the fluid-force generating system may be separately excited and connected to different frequency alternating current systems, and more than one power supply may be utilized. This is to enable the resonant velocity of the fluids passing over the electrodes in the throat area to be increased, and decreased thereafter as the width of the cross-sectional area increases.

The rate of flow of the fluids along the inner wall of the fluid-force-generation tunnel may be controlled by changing the frequency of the alternating potential impressed on one group of electrodes with respect to that of the next group. In order to maintain the flow of fluids through the fluid-force-generation tunnel at the desired high velocities and at the same time with the minimum of turbulence, the rate of flow of the fluid is generally varied in inverse proportion to the tunnel's cross-sectional area. For applications such as those illustrated in FIGS. 2 through 5 the rate of flow is controlled so that the product of the cross-sectional area, and the velocity of the fluid, is substantially constant at all points along the tunnel's inner surface. In some applications it is found advantageous to progressively decrease the product of the flow velocity times the cross-sectional; area along the flow path through the wind-generating tunnel. By proper adjustment of the system's power supply, fluids, such as air, may be made to flow at high velocities through the throat of the tunnel with a minimum of turbulence.

The term “charged particles” as used herein has reference to any fluid or non-fluid particles, regardless of size, which are attracted and/or repelled by an electrical charge and whose movements are influenced by electric fields. Therefore, the term “charged particles” has reference to ions in gasses and liquids regardless of how they are produced, and to charged particles of solid or liquid matter such as dust and water droplets, and to colloidal electrolytes, and to particles such as water molecules, and to numerous non-symmetrical polar organic and non-organic molecules, and to many other particles possessing these electrical movement properties.

The terms “surface layer fluid flow,” “laminar flow,” “fluid-force generation” and “laminar flow of fluids” and the like, as used herein designates a flow of fluid in a stratum, or layer, near or in contact with an adjacent surface.

The terms “progressively changing potentials” and “alternating potential(s)” and the like, as used herein, has reference to electric potentials in an electric field whose charged particles change polarity at each ring or group of electrode points with respect to the next ring or group of adjacent electrode points, that are located in the direction of the moving particles. The terms refer further to charged particles moving in a field, either as an essentially neutral potential or as an attracting potential that is maintained ahead of the moving particle. Thus, the term(s) have reference to both direct current fields of increasing attracting potential, and to alternating fields that produce true traveling waves, and to other periodically varied electrical fields that produce a traveling wave effect.

The term “corona discharge” as used herein has reference to the entire class of discharges that require a voltage to produce or maintain ionization. Such discharges include corona, glow, aura, and arc and spark discharges.

The methods of producing fluid flows with varying velocities described herein may be employed in a wide range of applications; for example, they may be used for various gaseous and liquid fluid handling systems, and also in the crushing of ore-bearing rocks by accelerating them to high velocities prior to crashing them into a hard surface. Although this invention has been described in connection with its application to specific fluid-flow systems and to the motivating force to drive various designed turbines for the production of electricity, various other applications and embodiments will occur to those skilled in the art. Therefore, it is not desired that this invention be limited to the applications described and illustrated herein, and it is intended by the appended claims to cover all modifications which fall within the scope and spirit of the invention.

What is claimed is:

1. A fluid moving system for producing substantially a laminar flow of ambient fluid over and adjacent to a mostly smooth surface, that is exposed and open to the fluid, which comprises a multiplicity of electrode elements mounted in spaced relationships to one another adjacent to the said smooth surface and electrically insulated from one another and constituting a series of elements extending along a portion of the surface and a means comprising a multiplicity of sharp points on predetermined ones of said elements oriented in the direction of fluid flow over the said elements for producing charged particles adjacent said predetermined ones of said elements, all of the said sharp points for each of the said elements lying substantially in a plane perpendicular to the direction of fluid flow and equidistant from the next element in the direction of the fluid flow, whereby the production of charged particles by a corona-type discharge is facilitated at each of the said sharp points, electric exciting means connected with the said electrode elements for producing progressively changing electric potentials along the said smooth surface thereby creating an electric potential field for propelling charged particles dispersed in the ambient fluid progressively from one electrode element toward the next and thereby inducing a surface layer fluid flow over the said portion of the surface, certain ones of the said predetermined elements comprising conducting bars having the said sharp points arranged in two sets pointing in opposite directions, auxiliary electrodes spaced from the said bars one on one side and one on the other of each of the said bars, and a mechanical or electronic switching means for selectively connecting each of the said bars alternatively to the auxiliary electrode on either side thereof for reversing the direction of the corona discharge and the direction of the moving charged particles.

2. A fluid moving system for producing a substantially laminar flow of ambient fluid over and adjacent to a predominantly smooth surface, exposed to the fluid, the said surface comprises a multiplicity of electrode elements mounted in a spaced relationship to one another and adjacent to the said surface and electrically insulated from one another and constituting a series of electrode elements extending along a portion of the said smooth surface, and an electrical exciting means connected to the said electrode elements for producing progressively changing electrode potentials along the said smooth surface thereby creating an electric potential field for propelling charged particles that are dispersed in the ambient fluid progressively from one electrode element toward the next and thereby inducing a surface layer fluid flow over the said portion of the smooth surface, the said exciting means comprising an alternating voltage source connected to excite the said electrode elements successively to electric potentials at predetermined phase differences between adjacent electrodes for producing a traveling wave effect and for propelling charged particles, that are dispersed in the fluid medium, progressively along the said smooth surface at a resonant velocity which is essentially the velocity of the traveling wave effect, and is dependent upon the frequency of the alternating voltage, and the phase relationship between the potentials applied to adjacent electrodes and the spacing between the electrode elements, the said exciting means further including means for generating a first alternating voltage having an essentially square wave form, and a means for applying the first said alternating voltage between every other odd-numbered electrode element in a series, and means for generating a second alternating voltage having the same wave form voltage and frequency as the said first alternating voltage, but with phase lagging approximately ninety degrees behind the said first alternating voltage and a means for applying the said second alternating voltage between every other even-numbered electrode element in a series.

3. A fluid moving system as set forth in claim 2 wherein the said means for generating the first and second alternating voltages comprises direct current sources of opposite polarity, and a switching means for applying periodic burst of said voltages, which thus constitute voltages of alternating square wave form.

4. A fluid moving system as set forth in claim 3 including means dependent upon the opening of the said switching means for forming a short high-voltage pulse, and impressing the said high-voltage pulse on the square wave voltages at predetermined points thereon.

5. A power supply consisting of a waveform generator capable of generating complex waveforms of any desired shape and also capable of providing any desired timeframe at zero voltage, and a multiple output phase shifter capable of generating multiple phase outputs with the total number of degrees of phase shift between individual voltage outputs being independently variable on each of the said outputs, and a series of voltage amplifiers adjustable over a wide range of voltages without distorting the chosen wave form or phase angle, and a series of high-voltage transformers to increase the voltage output of the said amplifiers, which thus operate in a manner wherein the power supply will provide all of the direct current and alternating current voltages, frequencies, wave forms, phase shifts, pulsing voltages and switching mechanisms as called for in claims 1, 2, 3 and 4.

6. A fluid moving system utilizing the power supply of claim 5 for producing a substantially laminar flow of ambient fluid over and adjacent to a predominantly smooth surface, exposed to the ambient fluid, which comprises a multiplicity of electrode elements mounted in a spaced relationship to one another adjacent to the said smooth surface and electrically insulated from one another and constituting a series of electrode elements extending along a portion of the said surface, and the power supply's electric exciting means connected with the said electrode elements for producing progressively changing electrode potentials along the said surface and thereby creating an electrical potential field for propelling the charged particles that are dispersed in the ambient fluid progressively from one electrode element towards the next and thereby producing a surface layer fluid flow over the said portion of the substantially smooth surface, said alternating current exciting voltage provided by the power supply of claim 5 and connected to excite the said electrode elements successively to electric potentials at predetermined phase differences between adjacent electrodes for producing a traveling wave effect, and for propelling the charged particles dispersed in the fluid medium progressively along the said surface at a resonant velocity which is substantially the velocity of the traveling wave effect and is dependent upon the frequency of the alternating voltage and the phase relationship between the potentials applied to the adjacent electrodes, and the spacing between electrode elements, said system utilizing the said power supply for generating an alternating voltage having an essentially flat-top wave form or a partially flat-top wave form with a spike at the wave's leading edge over a substantial portion of each half cycle, and having a nearly zero voltage for an appreciable period between flat-top portions, and for superposing a timed high voltage pulse on each half cycle, of the same polarity, on the flat-top wave on which it is superposed. Final section—page 5

7. A fluid moving system as set forth in claim 6 utilizing the power supply of claim 5 for adjusting the time of the high voltage pulse with respect to the flat-top wave form.

8. A fluid moving system as set forth in claim 6 utilizing the power supply of claim 5 for separately adjusting the voltage of the essentially flat-top portion occurring on each half cycle to control the velocity of the charged particles and thereby synchronize their movement with the velocity of the traveling wave effect.

9. A fluid moving system as set forth in claim 6 and utilizing the power supply of claim 5 for separately adjusting the voltage of the short pulse and thereby control the production of charged particles in the ambient fluid.

10. A fluid moving system as set forth in claim 6 and utilizing the power supply of claim 5 for adjusting the length of the essentially flat-top portion of each half cycle compared to the length of the nearly zero voltage portion, thereby affording an increase in efficiency by minimizing the capture of charged particles by electrodes and minimizing reversed propulsion of charged particles which can get out of synchronization with the traveling wave effect.

11. A fluid-force-moving system for producing a substantially laminar flow of ambient fluid over and adjacent to substantially smooth surface, exposed to the fluid, which comprises a multiplicity of electrode elements mounted in a spaced relationship to one another and constituting a series of electrode elements extending along a portion of the said mostly smooth surface, and using the power supply of claim 5 providing electric exciting of the said electrode elements for producing progressively changing electrical potentials along the said surface, thereby creating an electric potential field for propelling charged particles, that are dispersed in the ambient fluid, progressively from electrode element toward the next and inducing a surface layer fluid flow over the said portion of the surface, said exciting means provided by the power supply to excite the said electrode elements successively to electric potentials at predetermined phase differences between the adjacent electrodes for producing a traveling wave effect and for propelling charged particles dispersed in the fluid medium progressively along the said surface at a resonant velocity which is essentially the velocity of the traveling wave effect and is dependent upon the frequency of the alternating voltage and the phase relationship between the potentials applied to the adjacent electrodes and the spacing between electrode elements, whereby excitation of the said electrode produces a true traveling weave having a velocity dependent upon the frequency provided by the power supply, and the minimum distance between electrodes of the same phase relationship.

12. A fluid-force moving system as set forth in claim 11 including a means to adjust the minimum distance between excited electrodes of the same phase relationship for changing the velocity of the traveling wave.

13. A fluid-force moving system as set forth in claim 11 utilizing the power supply of claim 5 to change the frequency of the alternating potential for changing the velocity of the traveling wave. Final section—page 6

14. A paddle-wheel-type turbine provided with two fluid generating tunnels with one of the said tunnels positioned to cover essentially the upper half of the paddle wheel blades and the second of the said tunnels provided to substantially cover the bottom half of the said paddle-wheel blades, with the upper fluid-force generator producing controllable high-velocity fluids, such as ionic winds, in a static direction of say left to right thereby forcing the paddle wheel to turn counterclockwise, while the lower fluid-force generator is producing controllable high-velocity fluids flowing in the opposite direction, say right to left, of the said fluids produced in and by the upper fluid-force generator tunnel thereby augmenting the counterclockwise forces provided in the upper tunnel, and having both fluid-force generators provided electrical exciting power by the common power supply of claim 5 thereby substantially providing equal fluid forces from both the top and bottom fluid-force generating tunnels, and to further increase the overall efficiency of this paddle-wheel-type turbine having the generated fluids first travel through a narrow throat portion of the tunnel where the paddle wheel receives its thrust and then having additional electrodes in the exit portion of the tunnel to provide the said turbine with a suction force during and after the time it has applied its forces to the turbine blades, said exit portion of the fluid-force generator tunnel then being turned in a direction towards the inlet area of the opposite fluid-force generating tunnel thus giving the other generator a fluid-force directed in the center of its input end while not interfering with the laminar flows being produced by either of the fluid-force generator's electrode elements.

15. A fluid-force generator similar to the one described in claim 14 but having the tunnel portion with sides having the same dimensional cross section and thereby eliminating the need to provide for expanded electrode spacing because in this configuration there is no narrow throat portion of the tunnel to deal with.

16. A fluid-force generator similar to the one of claim 15, but instead of having opposing fluid-force generator tunnels a separate tunnel is used as a stand-alone fluid-force generator that may be applied in other types of turbines such as a Tesla turbine engine/pump wherein the propelling force is created by a boundary layer caused by the high speed of bladeless discs and wherein the fluid-force generator of the present invention is not used in the conventional manner as designed by Tesla, and others who have attempted improvements to Tesla's design, but rather the output of the fluid-force generator is designed to enter the turbine through more than one orifice and thereby influencing the disc to rotate at high speeds and thereby establishing a substantial amount of shaft horsepower without the use of any combustible materials or ignition thereof and thereby providing an abundance of non-polluting shaft horsepower that can be utilized for the production of electrical power or for any other purpose requiring shaft horsepower.

17. A fluid-force generator similar to the one in claim 15, but used as an energy source to cause the blades of a standard gas-type turbine to turn at high speeds and thereby creating a substantial amount of shaft horsepower that can be utilized for any purpose, such as for electrical power generation, without burning any fossil fuels and thereby being beneficial to the environment and also preserving some of the earth's dwindling supply of fossil fuels.
